(19) United States
(12) Patent Application Publication
(10) Pub. No.: US 2019/0249831 A1
(43) Pub. Date: Aug. 15, 2019

(54) LIGHT BULB APPARATUS

(71) Applicant: XIAMEN ECO LIGHTING CO. LTD., XIAMEN (CN)

(72) Inventors: Jinyong Liu, XIAMEN (CN); Hongkui Jiang, XIAMEN (CN); Hongbin Lin, XIAMEN (CN); Shiyong Li, XIAMEN (CN)

(21) Appl. No.: 15/894,905

(22) Filed: Feb. 12, 2018

(51) Int. Cl. F21K 9/238; F21V 29/74; F21S 10/04; F21V 29/83; F21V 23/04; F21K 9/232; F21V 23/00

(52) U.S. Cl. CPC F21K 9/238; F21V 29/74; F21S 10/043; F21Y 2107/70; F21V 23/0492; F21K 9/232; F21V 23/003; F21V 29/83

(57) ABSTRACT

A light bulb apparatus includes a flexible circuit board, LED modules, a control circuit, a driver circuit and a bulb head. The flexible circuit board is rolled as a hollow tube with a cap. The LED modules are disposed on the flexible circuit board. The control circuit is used for controlling turn-on and turn-off of the LED modules in a predetermined pattern. The driver circuit is connected with an electrode terminal on the cap. The bulb head receives external power supply.

### FIELD OF THE INVENTION

The present invention is related to a light bulb apparatus and more particularly related to a LED light bulb apparatus.

### BACKGROUND

Light devices are important in human daily life. In the past, people get used to simple light devices to do everything, including decoration and luminous needs. Along with light device technology developments, people want more and more variations of light devices for various purposes.

For example, people want to simulate a fire, a candle, or projects any desired symbols. Controlling and effect needs keep increasing while heat dissipation, robustness of such products remain very important.

Therefore, it is very beneficial to design more interesting product to satisfy various human life needs.

### SUMMARY OF INVENTION

According to an embodiment of the present invention, a light bulb apparatus includes a flexible circuit board, LED modules, a control circuit, a driver circuit and a bulb head.

The flexible circuit board is rolled as a hollow tube with a cap. In an embodiment, this is like a paper box folding, but only doing so with a flexible circuit board. The cap may be part of the flexible circuit board. Alternatively, there may be multiple flexible circuit board or multiple rigid circuit board folded and connected while a cap is placed on top of the tube.

In some other embodiments, the cap may be eliminated, and the flexible circuit board may be electrically connected to the driver circuit directory. Alternatively, the driver circuit may be placed on a driver board, which provides support to hold the rolled flexible circuit board.

Multiple LED modules disposed on the flexible circuit board. For example, more than 50 LED chips are mounted on the flexible circuit board with necessary wires to route to the control circuit and power source. SMD (Surface Mounted Device), flip chips, COB (Chip on Board), CSP (Chip scale package) may be used for mounting the LED modules on the flexible circuit board.

The flexible circuit board may be rolled as a cylinder tube or a polygonal tube, or any other geometrical shape.

The control circuit is used for controlling turn-on and turn-off of the LED modules in a predetermined pattern. In some embodiments, the control circuit is placed on the flexible circuit board together the LED modules. In some other embodiments, the control circuit may be placed with the driver circuit.

The driver circuit is connected with an electrode terminal on the cap. The electrode terminal may be further connected to the LED modules and the control circuit to supply electricity thereto.

The bulb head may have a standard interface, like an Edison bulb head standard for connecting to an external power source for supplying electricity to the driver circuit to generate a driving current to the plurality of LED modules and the control circuit via the electrode terminal of on the cap. The bulb head may be another interface to be installed on a customized decoration light device or various portable light devices.

In some embodiments, the light bulb apparatus may further include a metal tube. The flexible circuit board is rolled on a surface of the metal tube, and the metal tube helps dissipate heat generated by the LED modules.

In addition, the metal tube may have one or more holes to reduce manufacturing cot and enhance heat dissipation at the same time.

In some embodiments, the metal tube may have one or more heat dissipation fin structure for enhancing heat dissipation.

In some embodiments, certain heat dissipation gel or glue may be applied between the metal tube and the flexible circuit board to enhance heat dissipation.

In some embodiments, the flexible circuit board has a foldable metal substrate, like in aluminum material. Insulation layers and conductive wires may be formed on the foldable metal substrate.

In some embodiments, the flexible circuit board includes a plurality of rigid sub-circuit board folded to form the flexible circuit board. In other words, even the term flexible is used, it covers the case of using multiple folded rigid circuit boards.

In some embodiment, the electrode terminal includes a plug-in structure for a pin of the driver circuit to plug into the plug-in structure to be electrically connected to the LED module and the control circuit. Specifically, the plug-in structure may have certain elastic component to clip and hold the inserted pin when the pin of the driver circuit is plugged in. Furthermore, there may be usually two and sometimes more pins to be plugged into corresponding plug-in structures.

In some embodiments, the electrode terminal may have a pin to be plugged into a plug-in structure of the driver circuit to electrically connect the LED module and the control circuit to the driver circuit. In other words, the pin may exist in the electrode terminal of the cap or in the driver circuit.

The driver circuit may be placed on a driver plate with two rigid pins at peripheral end to be plugged into the cap of the flexible circuit board.

In some embodiments, 11, the predetermined pattern is a flame flashing effect, simulating a flame flashing effect. Specifically, the LED modules are turn-on and turn-off separately in a manner that overall appearance resembles a flame flashing.

In some embodiments, the plurality of LED modules are divided into multiple groups. The control circuit turns on and turns off the groups separately to form the flame flashing effect. In other words, in such design, the LED module is not controlled one by one, but in group. Such arrangement may save design complexity of the control circuit, which may decrease cost.

In addition, some groups of LED modules are arranged with a tilt direction on the flexible circuit board, with respect to the axis of the rolled flexible circuit board. This is particularly helpful for simulating flame flashing.

In some embodiments, the plurality of LED modules form a plurality of divisions on the flexible circuit board, each division forms a flame pattern. For example, the flexible circuit board is divided into three divisions and in each division, the LED modules are arranged like a flame symbol.

In some embodiments, the predetermined pattern is selected from a plurality of candidate patterns pre-stored in the control circuit. For example, one such bulb apparatus may have multiple pre-stored patterns to be selected. Users may turn all LED modules on to use the bulb apparatus as a normal LED bulb. In addition, the LED modules may be turned off partially to adjust light level of the bulb apparatus. When users need to animation of the bulb apparatus, they may turn on the simulation of flame flashing.

Such operation may be used by recognizing a traditional dimmer, a turn-on and turn-off pattern or a mechanical switch provided on the bulb apparatus.

In some embodiments, the control circuit is a micro controller and a program is coded for controlling the turn-on and turn-off of the plurality of LED modules.

In some embodiments, the control circuit has a memory device for storing a table recording turn-on and turn-off time diagram, the control circuit turns on and turns off the plurality of the LED modules based on the table. For example, the rows of the table represent to each LED module or a group of LED modules, and the column represents whether the corresponding LED module or the group of LED modules should be turned on or turned off in a time sequence. With such table, it is easy to change the pattern and simplify the design of the control circuit.

In some embodiments, the bulb apparatus may include an orientation switch to change the predetermined pattern when the light bulb apparatus is positioned at different orientation. For example, the bulb apparatus may be installed on a ceiling, by which the top of the bulb apparatus is facing downwardly. The bulb apparatus may also be installed aside a wall, by which the top of the bulb apparatus is facing upwardly. Flame has certain direction and the orientation switch may help, for example, the control circuit to keep the flame burning upwardly.

In some embodiments, the orientation switch may be a mechanical switch and in some other embodiments, the orientation switch is an automatic detector to detect an orientation of how the light bulb is placed.

In some embodiments, the control circuit may receive external commands from an external device like a mobile phone or an IoT (Internet of Things) gateway. In such case, the control circuit may receive a command from an external device to change the predetermined pattern to determine how to turn on and turn off the plurality of the LED modules.

### BRIEF DESCRIPTION OF DRAWINGS

FIG. 1 illustrates an embodiment of a light bulb apparatus.

FIG. 2 illustrates a component of the embodiment of FIG. 1.

FIG. 3 illustrates some other components of FIG. 1.

FIG. 4 illustrates some other components of FIG. 1.

FIG. 5 illustrates a perspective view of such embodiment.

### DETAILED DESCRIPTION

According to an embodiment of the present invention, a light bulb apparatus includes a flexible circuit board, LED modules, a control circuit, a driver circuit and a bulb head.

The flexible circuit board is rolled as a hollow tube with a cap. In an embodiment, this is like a paper box folding, but only doing so with a flexible circuit board. The cap may be part of the flexible circuit board. Alternatively, there may be multiple flexible circuit board or multiple rigid circuit board folded and connected while a cap is placed on top of the tube.

In some other embodiments, the cap may be eliminated, and the flexible circuit board may be electrically connected to the driver circuit directory. Alternatively, the driver circuit may be placed on a driver board, which provides support to hold the rolled flexible circuit board.

Multiple LED modules disposed on the flexible circuit board. For example, more than 50 LED chips are mounted on the flexible circuit board with necessary wires to route to the control circuit and power source. SMD (Surface Mounted Device), flip chips, COB (Chip on Board), CSP (Chip scale package) may be used for mounting the LED modules on the flexible circuit board.

The flexible circuit board may be rolled as a cylinder tube or a polygonal tube, or any other geometrical shape.

The control circuit is used for controlling turn-on and turn-off of the LED modules in a predetermined pattern. In some embodiments, the control circuit is placed on the flexible circuit board together the LED modules. In some other embodiments, the control circuit may be placed with the driver circuit.

The driver circuit is connected with an electrode terminal on the cap. The electrode terminal may be further connected to the LED modules and the control circuit to supply electricity thereto.

The bulb head may have a standard interface, like an Edison bulb head standard for connecting to an external power source for supplying electricity to the driver circuit to generate a driving current to the plurality of LED modules and the control circuit via the electrode terminal of on the cap. The bulb head may be another interface to be installed on a customized decoration light device or various portable light devices.

In some embodiments, the light bulb apparatus may further include a metal tube. The flexible circuit board is rolled on a surface of the metal tube, and the metal tube helps dissipate heat generated by the LED modules.

In addition, the metal tube may have one or more holes to reduce manufacturing cot and enhance heat dissipation at the same time.

In some embodiments, the metal tube may have one or more heat dissipation fin structure for enhancing heat dissipation.

In some embodiments, certain heat dissipation gel or glue may be applied between the metal tube and the flexible circuit board to enhance heat dissipation.

In some embodiments, the flexible circuit board has a foldable metal substrate, like in aluminum material. Insulation layers and conductive wires may be formed on the foldable metal substrate.

In some embodiments, the flexible circuit board includes a plurality of rigid sub-circuit board folded to form the flexible circuit board. In other words, even the term flexible is used, it covers the case of using multiple folded rigid circuit boards.

In some embodiment, the electrode terminal includes a plug-in structure for a pin of the driver circuit to plug into the plug-in structure to be electrically connected to the LED module and the control circuit. Specifically, the plug-in structure may have certain elastic component to clip and hold the inserted pin when the pin of the driver circuit is plugged in. Furthermore, there may be usually two and sometimes more pins to be plugged into corresponding plug-in structures.

In some embodiments, the electrode terminal may have a pin to be plugged into a plug-in structure of the driver circuit to electrically connect the LED module and the control circuit to the driver circuit. In other words, the pin may exist in the electrode terminal of the cap or in the driver circuit.

The driver circuit may be placed on a driver plate with two rigid pins at peripheral end to be plugged into the cap of the flexible circuit board.

In some embodiments, 11, the predetermined pattern is a flame flashing effect, simulating a flame flashing effect. Specifically, the LED modules are turn-on and turn-off separately in a manner that overall appearance resembles a flame flashing.

In some embodiments, the plurality of LED modules are divided into multiple groups. The control circuit turns on and turns off the groups separately to form the flame flashing effect. In other words, in such design, the LED module is not controlled one by one, but in group. Such arrangement may save design complexity of the control circuit, which may decrease cost.

In addition, some groups of LED modules are arranged with a tilt direction on the flexible circuit board, with respect to the axis of the rolled flexible circuit board. This is particularly helpful for simulating flame flashing.

In some embodiments, the plurality of LED modules form a plurality of divisions on the flexible circuit board, each division forms a flame pattern. For example, the flexible circuit board is divided into three divisions and in each division, the LED modules are arranged like a flame symbol.

In some embodiments, the predetermined pattern is selected from a plurality of candidate patterns pre-stored in the control circuit. For example, one such bulb apparatus may have multiple pre-stored patterns to be selected. Users may turn all LED modules on to use the bulb apparatus as a normal LED bulb. In addition, the LED modules may be turned off partially to adjust light level of the bulb apparatus. When users need to animation of the bulb apparatus, they may turn on the simulation of flame flashing.

Such operation may be used by recognizing a traditional dimmer, a turn-on and turn-off pattern or a mechanical switch provided on the bulb apparatus.

In some embodiments, the control circuit is a micro controller and a program is coded for controlling the turn-on and turn-off of the plurality of LED modules.

In some embodiments, the control circuit has a memory device for storing a table recording turn-on and turn-off time diagram, the control circuit turns on and turns off the plurality of the LED modules based on the table. For example, the rows of the table represent to each LED module or a group of LED modules, and the column represents whether the corresponding LED module or the group of LED modules should be turned on or turned off in a time sequence. With such table, it is easy to change the pattern and simplify the design of the control circuit.

In some embodiments, the bulb apparatus may include an orientation switch to change the predetermined pattern when the light bulb apparatus is positioned at different orientation. For example, the bulb apparatus may be installed on a ceiling, by which the top of the bulb apparatus is facing downwardly. The bulb apparatus may also be installed aside a wall, by which the top of the bulb apparatus is facing upwardly. Flame has certain direction and the orientation switch may help, for example, the control circuit to keep the flame burning upwardly.

In some embodiments, the orientation switch may be a mechanical switch and in some other embodiments, the orientation switch is an automatic detector to detect an orientation of how the light bulb is placed.

In some embodiments, the control circuit may receive external commands from an external device like a mobile phone or an IoT (Internet of Things) gateway. In such case, the control circuit may receive a command from an external device to change the predetermined pattern to determine how to turn on and turn off the plurality of the LED modules.

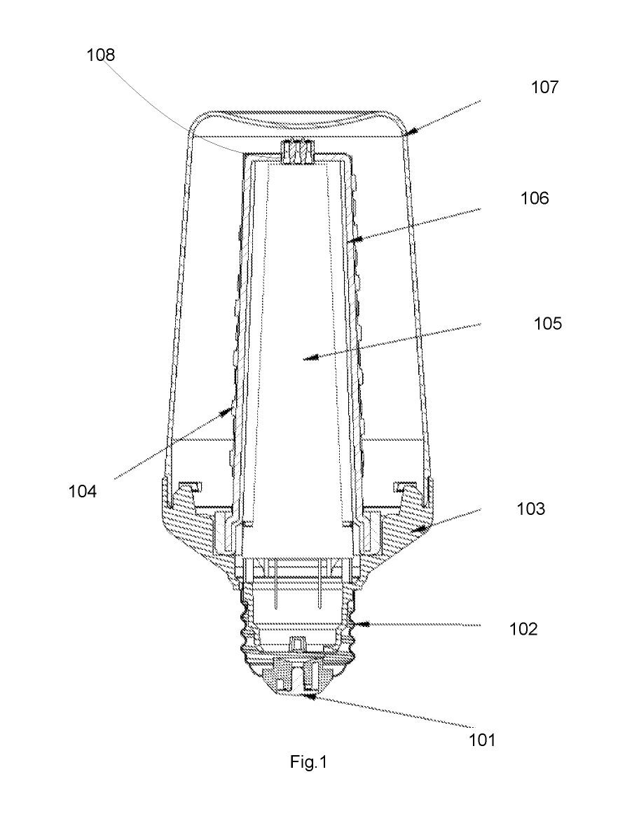

Please refer to FIG. 1 to FIG. 4, which illustrate an embodiment of the present invention.

In FIG. 1, the bulb apparatus has a shell 107, a driver circuit 105, a flexible circuit board 104 with a cap 108 at its top, a metal tube 106, a bottom electrode 101, a side electrode 102 and a bulb head portion 103.

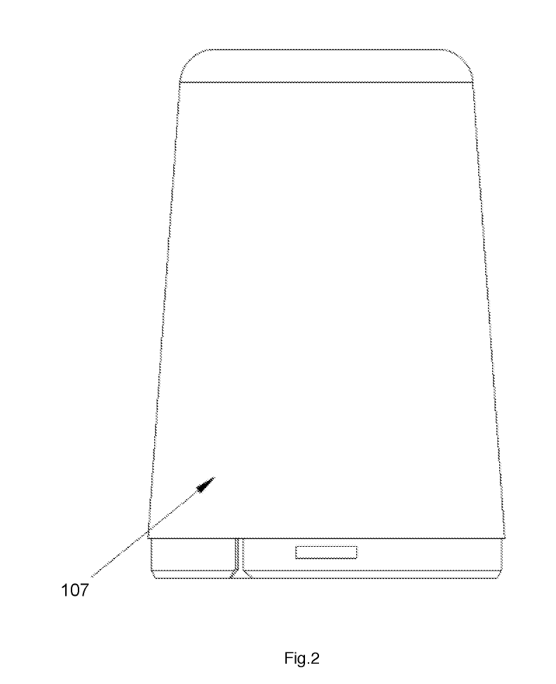

In FIG. 2, the shell 107 is illustrated as an example, and may be varied to any other shapes.

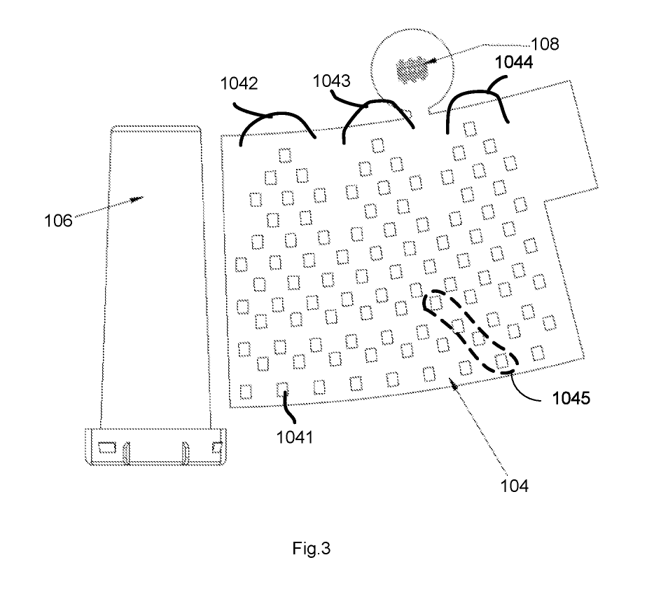

In FIG. 3, it is illustrated a relation between the un-rolled flexible circuit board 104 and the metal tube 106. The metal tube 106 is made of metal for providing better heat dissipation. The flexible circuit board 104 is rolled on the metal tube 106. The cap 108 is folded so that its plug-in structure may engage pins from the driver circuit 105.

In FIG. 3, it is also illustrated that the LED modules may be grouped, particularly grouped in a tilt manner like the dashed circle 1045. The tilt manner is relative to the axis of the metal tube 106. The LED module 1041 may be made of various structure or packages. Furthermore, there may be different LED modules 10141, e.g. with different color temperatures to be placed on the flexible circuit board 104.

When the flexible circuit board 104 is rolled, the LED modules may be divided into several divisions facing different view angles. For example, the LED modules are divided into three divisions 1042, 1043 and 1044 in this illustrated example.

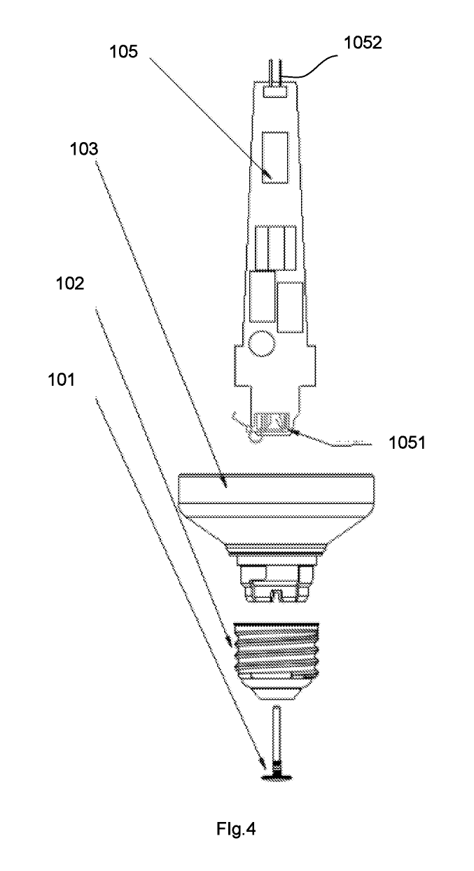

In FIG. 4, the driver circuit 105 has two pins 1052 to be plugged into associated plug-in structures on the cap 108 of FIG. 3. The driver circuit 105 also has a terminal to be connected to external power source via the side electrode 102 and the bottom electrode 101 of the bulb head portion 103.

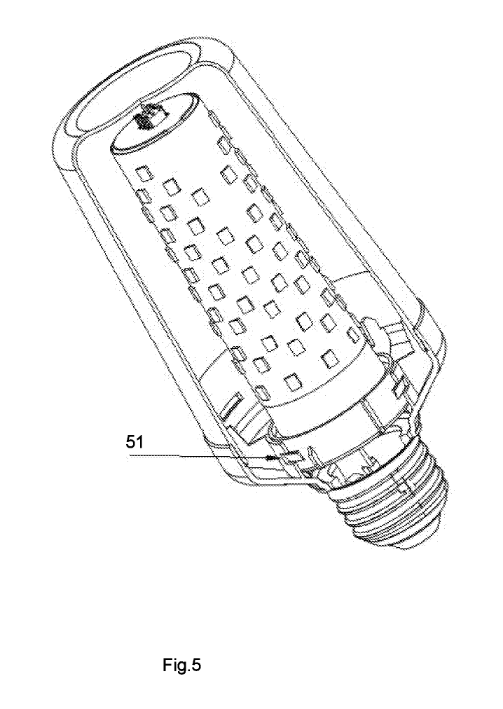

FIG. 5 illustrates a perspective diagram showing how such bulb apparatus may look like. However, please be noted that other variations may be performed and still fall in the invention scopes, while they are taught based on previous disclosures.

In addition to the above-described embodiments, various modifications may be made, and as long as it is within the spirit of the same invention, the various designs that can be made by those skilled in the art are belong to the scope of the present invention.

1. A light bulb apparatus, comprising:
a flexible circuit board rolling as a hollow tube with a cap;
a plurality of LED modules disposed on the flexible circuit board;
a control circuit for controlling turn-on and turn-off of the LED modules in a predetermined pattern;
a driver circuit connected with an electrode terminal on the cap; and
a bulb head with a standard interface for connecting to an external power source for supplying electricity to the driver circuit to generate a driving current to the plurality of LED modules and the control circuit via the electrode terminal of on the cap.

2. The light bulb apparatus of claim 1, further comprising a metal tube, wherein the flexible circuit board is rolled on a surface of the metal tube, and the metal tube helps dissipate heat generated by the LED modules.

3. The light bulb apparatus of claim 2, wherein the metal tube has at least a hole for enhancing heat dissipation.

4. The light bulb apparatus of claim 2, wherein the metal tube has at least a fin structure for enhancing heat dissipation.

5. The light bulb apparatus of claim 2, wherein there is heat dissipation gel applied between the metal tube and the flexible circuit board.

6. The light bulb apparatus of claim 2, wherein the flexible circuit board has a foldable metal substrate.

7. The light bulb apparatus of claim 1, wherein the flexible circuit board comprises a plurality of rigid sub-circuit board folded to form the flexible circuit board.

8. The light bulb apparatus of claim 1, wherein the electrode terminal comprises an plug-in structure for a pin of the driver circuit to plug into the plug-in structure to be electrically connected to the LED module and the control circuit.

9. The light bulb apparatus of claim 8, wherein the plug-in structure comprises an elastic component to clip and hold the pin of the driver circuit.

10. The light bulb apparatus of claim 9, wherein the electrode terminal comprises a pin to be plugged into a plug-in structure of the driver circuit to electrically connect the LED module and the control circuit to the driver circuit.

11. The light bulb apparatus of claim 1, wherein the predetermined pattern is a flame flashing effect.

12. The light bulb apparatus of claim 11, wherein the plurality of LED modules are divided into multiple groups, the control circuit turns on and turn off the groups separately to form the flame flashing effect.

13. The light bulb apparatus of claim 12, wherein at least a group of LED modules are arranged with a tilt direction on the flexible circuit board.

14. The light bulb apparatus of claim 11, wherein the plurality of LED modules form a plurality of divisions on the flexible circuit board, each division forms a flame pattern.

15. The light bulb apparatus of claim 11, wherein the predetermined pattern is selected from a plurality of candidate patterns pre-stored in the control circuit.

16. The light bulb apparatus of claim 1, wherein the control circuit is a micro controller and a program is coded for controlling the turn-on and turn-off of the plurality of LED modules.

17. The light bulb apparatus of claim 16, wherein the control circuit has a memory device for storing a table recording turn-on and turn-off time diagram, the control circuit turns on and turns off the plurality of the LED modules based on the table.

18. The light bulb apparatus of claim 1, further comprising an orientation switch to change the predetermined pattern when the light bulb apparatus is positioned at different orientation.

19. The light bulb apparatus of claim 18, wherein the orientation switch is an automatic detector to detect an orientation of how the light bulb is placed.

20. The light bulb apparatus of claim 1, wherein the control circuit receives a command from an external device to change the predetermined pattern to determine how to turn on and turn off the plurality of the LED modules.
